(19) United States
(12) Patent Application Publication
(10) Pub. No.: US 2001/0036253 A1
(43) Pub. Date: Nov. 1, 2001

(54) Answering machine having selective screening of incoming telephone calls

(76) Inventor: John E. Heinzman, Palmdale, CA (US)

Correspondence Address: Roger A. Marrs, Suite 1120, 15233 Ventura Blvd., Sherman Oaks, CA, 91403, US

(21) Appl. No.: 09/803,481

(22) Filed: Mar. 9, 2001

Related U.S. Application Data
(60) Provisional application No. 60/189,323, filed on Mar. 14, 2000.

(51) Int. Cl. H04M 1/64

(52) U.S. Cl. 379/67.1

(57) ABSTRACT

An answering machine for selectively screening incoming telephone calls whereby unwanted calls are blocked or diverted to a voice mail record. Circuits are provided for an internal memory which stores a plurality of individual codes wherein each code is assigned to a particular person from whom telephone messages are welcome. Additional circuitry is used for receipt of the personal code which is forwarded to a comparator circuit for comparison with the individual code in the internal memory so that when a match occurs, a signal is produced and sent to a ringer circuit or if no answer, a message can be sent to voice mail for recording. Also, a circuit connects the comparator circuit to the voice mail in the event an unaccepted code is received whereby a lack of matching permits the message to be introduced to the voice mail record. The decoder circuit which includes the internal memory, the comparator circuit and the individual code is interrogated via s subject selector which is operated by a code switch so that the user of the machine can program to either introduce a coded address directly to the personal code circuit in the decoder or if the switch is placed in an alternative condition, the subject selector can be bypassed and the incoming signal sent directly to the personal code for decoding in the decoder circuit.

### BACKGROUND OF THE INVENTION

1. Field of the Invention

The present invention relates to the field of telephone monitoring systems, and more particularly to an answering machine having circuitry screening incoming phone calls by means of a caller code which is decoded by the circuitry so that the telephone bell will ring or a message sent to a voice mail storage or if no code employed, the incoming call is sent to voice mail storage automatically.

2. Brief Description of the Prior Art

In the past, it has been the usual practice to use answering machines that receive incoming calls and which will either cause the telephone bell to ring in order to attract attention or after so many rings, the incoming call is transferred to a voice mail storage for subsequent retrieval. However, difficulties and problems have been encountered with conventional answering machines which stem largely from the fact that there is no suppression circuit for blocking undesired incoming calls so that either the recipient of the calls must answer the phone or if unavailable, the unwanted messages are introduced to the voice mail storage. Also, conventional answering machines do not provide a switch by which the user can elect whether or not to receive certain callers and their message or to block certain callers so that their message will not be introduced to voice mail storage. In other words, the user of the answering machine does not currently have the option of blocking or accepting certain incoming telephone calls.

Therefore, a long-standing need has existed to provide an answering machine having a blocking circuit for selectively screening incoming telephone calls so that unwanted and undesired calls are either blocked or automatically passed to a recorder such as a voice mail storage device.

### SUMMARY OF THE INVENTION

Accordingly, the above problems and difficulties are avoided by the present invention which provides a novel answering machine having means for selectively screening incoming telephone calls so that undesired or unwanted calls are blocked or diverted to a voice mail record. Circuits are also provided for including an internal memory which stores a plurality of individual codes wherein each code is assigned to a particular person from whom telephone messages are welcome. Additional circuitry is provided for receipt of the personal code and this information is provided to a comparator circuit and compared with the personalized code information in the internal memory so that when a match occurs, a signal is produced and sent to a ringer circuit or if no answer, a message can be sent to voice mail for recording. Also, a circuit is provided connecting the comparator circuit to the voice mail in the event an unaccepted code is received so that a lack of matching permits the message to be introduced to the voice mail record. The decoder circuit which includes the internal memory, the comparator circuit and the personal code is interrogated via a subject selector which is operated by a code switch so that the user of the answering machine can program the answering machine to either introduce a coded address directly to the personal code circuit in the decoder or if the switch is placed in an alternate condition, the subject selector can be bypassed and the incoming signal sent directly to the personal code for decoding in the decoder circuit. An input circuit is employed into which the phone line is connected and a received telephone call is then introduced to an announcement to enter code circuit or network where a voice request is audibly announced requesting that the caller enter his or her personal code. A no code network is connected to the announcement to enter code circuit so that when there is a lack of personalized code being entered, the message will go directly to the voice mail for recording. Switch means are provided for determining the number of rings of a bell in a ringer circuit and if there is no answer, the voice mail record is actuated for receiving the voice mail signal or message.

Therefore, it is among the primary objects of the present invention to provide a novel answering machine having means for blocking or for permitting incoming calls to be forwarded to a decoding circuit whereby selected callers are permitted access to the telephone answering system.

Another object of the present invention is to provide a novel answering machine with a decoding circuit which receives incoming personalized calls and which permits only those calls which have been prerecorded in accordance with personalized codes to be passed or transmitted to either a ringing circuit or a voice mail record.

A further object of the present invention is to provide an answering machine having selective screening for incoming telephone calls whereby the incoming calls are identified by a personalized code in order to operate the telephone answering circuits in a normal manner.

Yet another object resides in providing a telephone ringer circuit which sends signals to other remote ringers in a household and which also has a multi-position switch in which to determine desired number of rings before referring the incoming call to voice mail.

Yet an additional object resides in providing an answering machine with privacy circuits so that selective screening is achieved for incoming telephone calls whereby only properly identified incoming calls will be passed through the machine to either a ringing circuit or a voice mail record.

### BRIEF DESCRIPTION OF THE DRAWINGS

The features of the present invention which are believed to be novel are set forth with particularity in the appended claims. The present invention, both as to its organization and manner of operation, together with further objects and advantages thereof, may best be understood with reference to the following description, taken in connection with the accompanying drawings in which:

FIG. 1 is a diagrammatic view of a conventional telephone used in combination with an answering machine having selective screening for incoming telephone calls in accordance with the present invention;

FIG. 2 is a diagrammatic perspective view of the answering machine shown in FIG. 1 illustrating location of major components therein; and

FIG. 3 is a block diagram illustrating the flow of information between blocks and which illustrates the system incorporating the present invention.

### DESCRIPTION OF THE PREFERRED EMBODIMENT

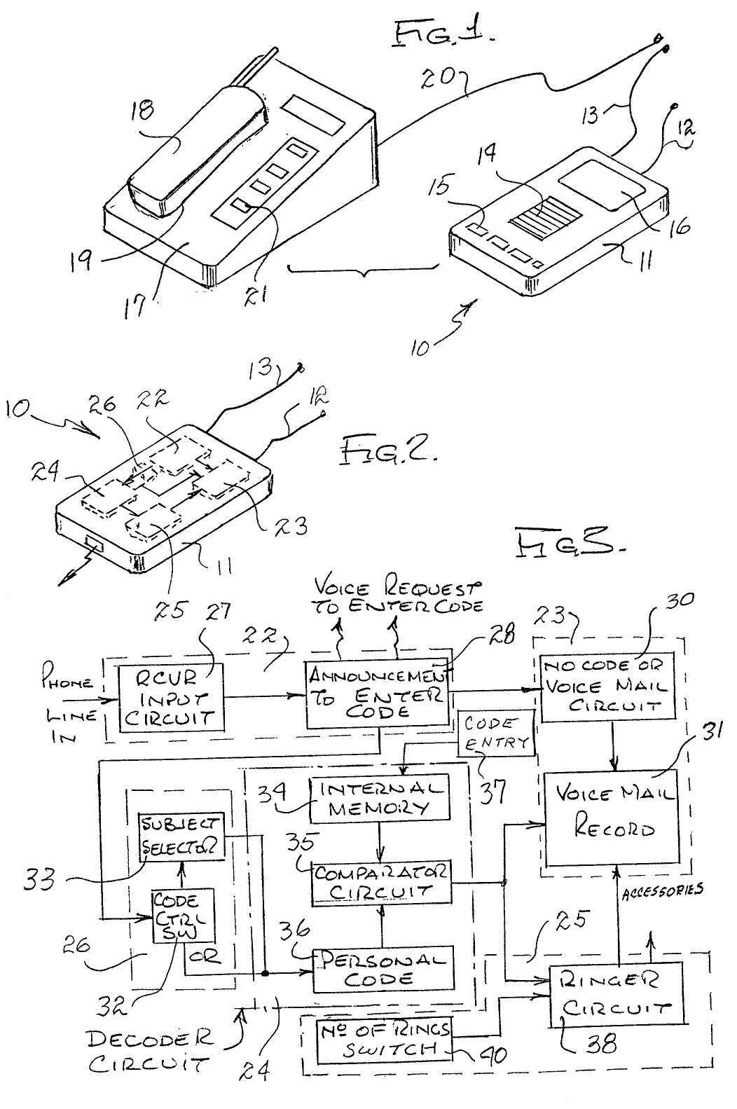

Referring to FIG. 1, the novel answering machine for screening incoming telephone calls is illustrated in the general direction of arrow 10 and the machine is included within a cabinet 11 having a power input 12 and a signal input 13. The answering machine further includes a loudspeaker beneath grid 14 and a plurality of control buttons such as button 15 is also included. An answering tape may be placed in a compartment under lid 16. The answering machine 10 is used in connection with a conventional telephone set that is carried on a case 17. The telephone set includes a handset 18 which is stored in a well 19 on the top of a panel. The telephone is of conventional design and an interconnecting cable to a wall phone jack is illustrated by numeral 20. A plurality of buttons or controls 21 are included for special functions such as redial, last number, etc.

Referring now to FIG. 2, the telephone answering machine 10 includes the incoming inconnecting cable 13 and the power cable 12. Within the cabinet 11, there is provided a code/no code circuit 22 that is connected in parallel to either a voice mail circuit 23 or to a decode circuit 24. The decode circuit is introduced to a ringing circuit 25 which in turn is coupled to the voice mail circuit 23. A subject selector circuit 26 interconnects the telephone input line circuit 22 with the decoder 24. The answering machine user may employ the subject selector circuit to program what subject matter or category is to be permitted access to the decoder.

Referring now in detail to FIG. 3, an incoming telephone call is introduced to the RCUR input circuit 27 and then to an announcement to enter code circuit 28. Both of these circuits are within the input circuit 22. The announcement to enter code circuit initiates audible instructions to the caller to enter the access code or, alternately, to hold for voice mail recording. If the caller does not enter a code, the call is sent to the voice mail network 23 via a no code or voice mail circuit 30. For the voice mail message, when no code has been entered, it is then forwarded to the voice mail record 31. In the event that the caller does enter a code, the incoming call is forwarded to the selector circuit 26. The selector circuit includes a code circuit switch 32 which is preset or programmed by the answering machine user so as to specify a personalized code or subject matter code so that only the switch selected subject matter code is forwarded to the decoding circuit 24. The code circuit switch is connected to the decoding circuit 24 by means of a subject select circuit 33.

The decode circuit 24 includes three major circuits or networks which are the internal memory circuit 34, a comparator circuit 35 and a personal code circuit 36. A code entry means 37 is provided whereby the answering machine user can introduce the subject matter or personalized code into the internal memory 34 where the information is stored for future use. The comparator circuit 35 is employed for comparing the preprogrammed select subject matter or personalized code in the internal memory with the personalized code 36 introduced from the selector circuit 26. Should there be a mismatch in the comparator circuit, the unaccepted code would then forward the incoming telephone message directly to the voice mail record 31. However, an accepted code match in the comparator circuit will cause the circuit to be introduced to the ringing circuit 38 in the ringer means 25 so that the answering machine user will know that an incoming telephone call is being received. The number of rings in the ringer circuit 25 is set by a switch 40 which controls the ringer in the circuit 38. After so many rings are sounded without the answering machine user picking up the receiver 10, the incoming message is transferred directly to the voice mail record 31 for future review by the answering machine user.

In review, an incoming call goes through the input circuit 27 and eventually is either decoded or not decoded depending upon the subject selector circuit and the comparator circuit 35. The decoder has a four position switch 32 which determines subject, class or level depending on the setting in the subject selector 33 relating to desired calls to be accepted. For example, codes in the “1000” range belong to close family, codes with the “2000” range relate to important business associates while codes in the “3000” range relate to acquaintances. The decoder circuit evaluates the input code information and then refers unaccepted calls to the voice mail record circuit 31 while accepted codes activate the ringer 38. The ringer sounds and sends a signal to other remote ringers in a home which are identified as accessories. The ringer also has a four position switch 40 to determine desired number of rings before referring call so voice mail 31.

The voice mail record will play an audible message to the incoming telephone caller which, for example, may be “Thank you for calling, although we cannot personally answer your call at this time, please leave a message”. After this voice mail message, the incoming call message is recorded in the voice mail record.

Therefore, it can be seen that the novel telephone selection system of the present invention permits only desired and incoming telephone calls to be forwarded to the ringer attracting the attention of the answering machine user who then can pick up the telephone handset and converse with the selected caller. In the event the telephone answering machine user is not available, the message will be transferred to the voice mail record.

While particular embodiments of the present invention have been shown and described, it will be obvious to those skilled in the art that changes and modifications may be made without departing from this invention in its broader aspects and, therefore, the aim in the appended claims is to cover all such changes and modifications as fall within the true spirit and scope of this invention.

What is claimed is:

1. A telephone answering machine comprising:
an internal computer network for comparing a personalized code with a previously stored personalized;
signal producing means in said internal computer network for generating a comparison signal in response to a positive comparison;
a voice mail circuit;
a ringer circuit coupled in parallel with said voice mail circuit to said signal producing means responsive to said comparison signal to activate said ringer circuit and said voice mail circuit; and
a selector circuit coupled to said internal computer network for permitting preset ones of said personalized code to be applied to said internal computer network.

2. The telephone answering machine defined in claim 1 wherein:
said internal computer network includes a comparator circuit coupled to said signal producing means;
an internal memory circuit connected to said comparator circuit; and
a personal code circuit coupled to said comparator circuit.

3. The telephone answering machine defined in claim 2 including:
an input circuit for receiving incoming telephone calls;
vocal announcement circuit responsive to said incoming telephone calls generating a vocal request to enter said personalized code; and
said vocal announcement circuit coupled between said input circuit and said selector circuit.

4. The telephone answering machine defined in claim 3 including:
a code entry means connected to said internal memory for manually entering code data therein for use in comparing with said personalized code in said personal code circuit via said comparator circuit.

5. The telephone answering machine defined in claim 4 wherein:
said selector circuit includes a subject selector for storing data of a specific category and a selector switch for activating said subject selector.

6. The telephone answering machine defined in claim 5 including:
an announcement means connected between said voice circuit and said selector circuit for receiving and with said personalized vocal voice code and responding with voice request to enter said voice code in the absence thereof.
